(19) United States
(12) Patent Application Publication
(10) Pub. No.: US 2003/0216606 A1
(43) Pub. Date: Nov. 20, 2003

(54) Method and apparatus for permanent and safe disposal of radioactive waste

(76) Inventor: Dean S. Engelhardt, Covina, CA (US)

Correspondence Address: Angus C. Fox, III, 4093 N. Imperial Way, Provo, UT, 84604-5386, US

(21) Appl. No.: 10/365,205

(22) Filed: Feb. 11, 2003

Related U.S. Application Data
(60) Provisional application No. 60/355,620, filed on Feb. 11, 2002.

(51) Int. Cl. G21F 9/00

(52) U.S. Cl. 588/16

(57) ABSTRACT

A method of disposing of radioactive waste comprising the steps of: providing a pressure-equalizing container; filling the pressure-equalizing container with radioactive waste; and burying the waste filled container in a subduction fault region of the earth's crust. For a preferred embodiment of the process, the waste filled containers are buried in the mud on the ocean floor in a subduction fault region. Preferably, the containers are placed on the ocean side of the fault, rather than the continental shelf side. The pressure-equalizing container is preferably fabricated from stainless steel, with a lead seal, although containers fabricated from ceramic materials may also be used. The waste-filled containers are tranported by ship to the area above a subduction fault, and an unpressurized, remote-controlled “submarine crawler” takes a number of containers to the ocean floor and buries them there, individually, in the mud or sediments.

This application has a priority date based on Provisional Patent Application No. 60/355,620, which has a filing date of Feb. 11, 2002.

### BACKGROUND OF THE INVENTION

1. Field of the Invention

This invention relates to methods and apparatus for permanently disposing of high and low-level nuclear waste.

2. Description of the Prior Art

One of the primary problems associated with the generation of electrical power via nuclear fusion is the disposal of radioactive waste. Uranium-fueled, light-water reactors, which are commonly used in the U.S., produce plutonium 239 as one of the waste byproducts. Not only is plutonium 239 extremely poisonous, it has a half-life of 24,400 years. That means that this element would be dangerous to man for about a quarter of a million years.

Retrieval of high-level nuclear waste by terrorists is another potentially grave problem. Sophisticated terrorists may separate the plutonium from the waste in order to build thermonuclear weapons. Less sophisticated terrorists may simply use the high-level waste to build a dirty conventional bomb.

Proposals for disposing of nuclear waste have included embedding the waste in a plastic binder and burying it, storing it above and below ground in special vaults, and encasing the material in a leakproof material and dropping it to the ocean floor. It has even been proposed that high-level nuclear waste be loaded aboard a rocket and sent into outer space.

None of these proposals provide safe permanent storage of the radioactive material. Nor are terrorists prevented from retrieving stored material. Any conventional disposal site will require round-the-clock security.

What is needed is a disposal method that is both safe and permanent and, due to the nature of the process, not require any further security once the waste has been packaged and placed.

### SUMMARY OF THE INVENTION

A primary object of the present invention is to provide a method for safe disposal of high and low-level radioactive waste. Radioactive waste is loaded into special containers and placed in locations where it will never be a hazard to life on the planet.

It is hypothesized that the majority of the internal heat of this planet comes from radioactive decay below the earth's crust. Therefore, placing the waste below the earth's crust will have no measurable effect on the earth's interior temperature. The capacity of the earth's core is so vast as to be limitless for all practical purposes.

Referring now to FIGS. 1 and 2, the earth's interior has slow-moving currents of molten rock that move in a direction toward the center of the earth in the vicinity of subduction faults. These subduction faults provide a natural pathway for nuclear waste disposal with an increase in safety and security, at a fraction of the cost over the long term, as compared to the storage methods now being used and considered.

Another primary objective of the present invention is to provide a disposal container that is designed for burial in sediment on the ocean floor near a subduction fault. To eliminate the possibility of leakage, the container must be of a pressure-equalizing design. These disposal containers are designed to be with high- or low-level radioactive waste, transported to the ocean floor next to a subduction fault, and buried in the mud.

Another primary objective of the present invention is to provide a method for transporting filled disposal containers to a subduction fault region. The method involves utilizing an unpressurized “submarine crawler” that can carry a number of containers and bury these in sediments on the sea floor. Once the containers are buried, this completes any action needed to completely eliminate it as a danger or hazard, as it will be drawn slowly via tectonic forces at the subduction fault into the upper mantle of the interior of the earth. Once there, it is unable to the surface due to the mass of the waste, which is considerably greater than the surrounding rock. Over many thousands of years, the containers will settle toward the earth's center due to local earthquake activity shaking the surrounding rock. Eventually, the waste will come to rest on the outer surface of the inner core of the earth (See FIG. 5).

### BRIEF DESCRIPTION OF THE DRAWINGS

Reference to items in the specification is made by identifying the Figure number followed by a period and the item number. For example, item 8 of FIG. 14 is referred to as FIG. 14.8

FIG. 1 is a cutaway of the plastic flow of molten rock in the earth's interior;

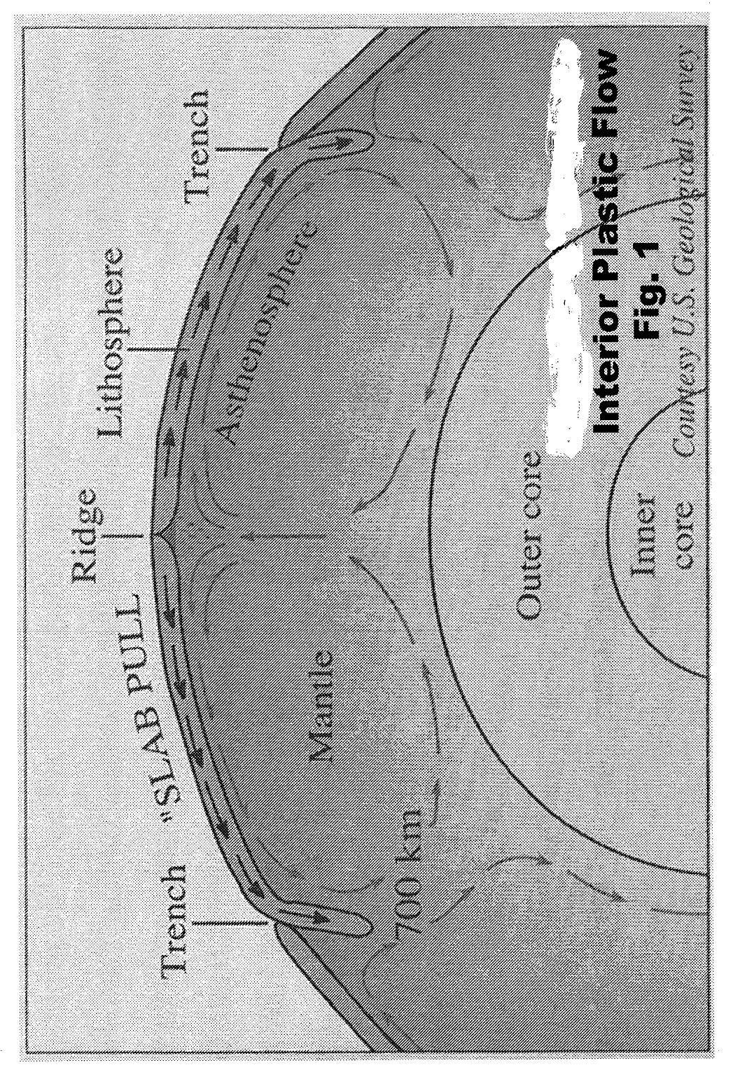

FIG. 2 is a world map showing some of the suitable subduction fault locations;

FIG. 3 is a cutaway view, showing the details of a subduction fault;

FIG. 4 is a detail of a submarine crawler drilling into the seabed sediments and depositing a row of containers;

FIG. 5 is a simplified view of the waste's path toward the center of the earth;

FIG. 6 is a perspective view of the drill/insertion assembly;

FIG. 7 is a cutaway of the drill/insertion assembly with a container in place as assembled;

FIG. 8 shows how the assembly in FIG. 7 disassembles when the container is buried;

FIG. 9 is a perspective view of a preferred embodiment of a disposal container;

FIG. 10 is a cutaway of the disposal container shown in FIG. 9;

FIG. 11 is a detail of the forward edge of the scrapper on the piston-plug showing the lead seal;

FIG. 12 is a cross-section of a copper O-ring filled with nitrogen;

FIG. 13 is a cutaway of a disposal container designed for free-drop penetration of the sea floor;

FIG. 14 is a sketch of the submarine crawler with the drilling assembly during the drilling into the seabed; and

FIG. 15 is a sketch of the submarine crawler of FIG. 14, after the container and drill bit has been released and the insertion tube is being withdrawn.

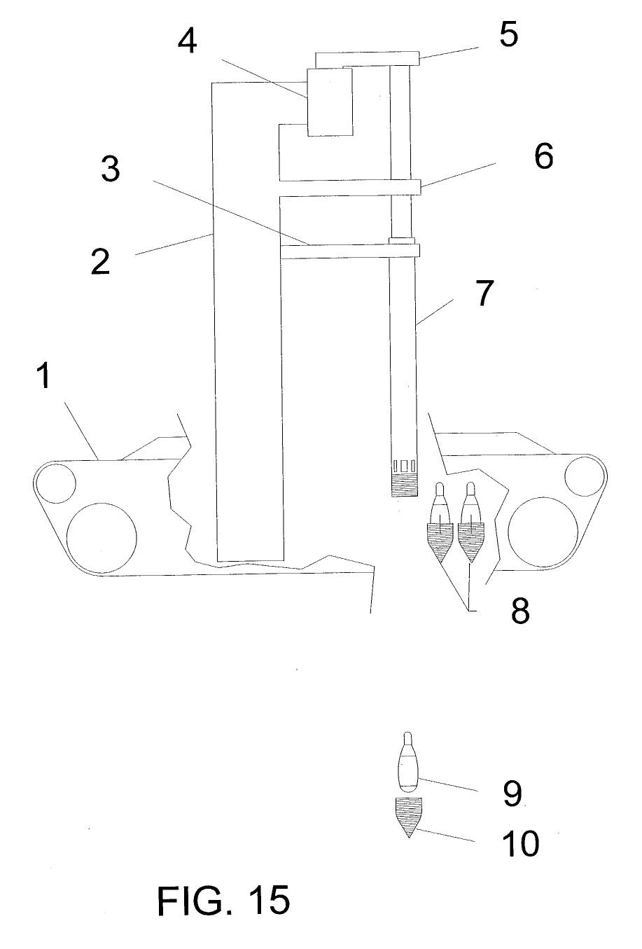

### DETAILED DESCRIPTION OF THE INVENTION

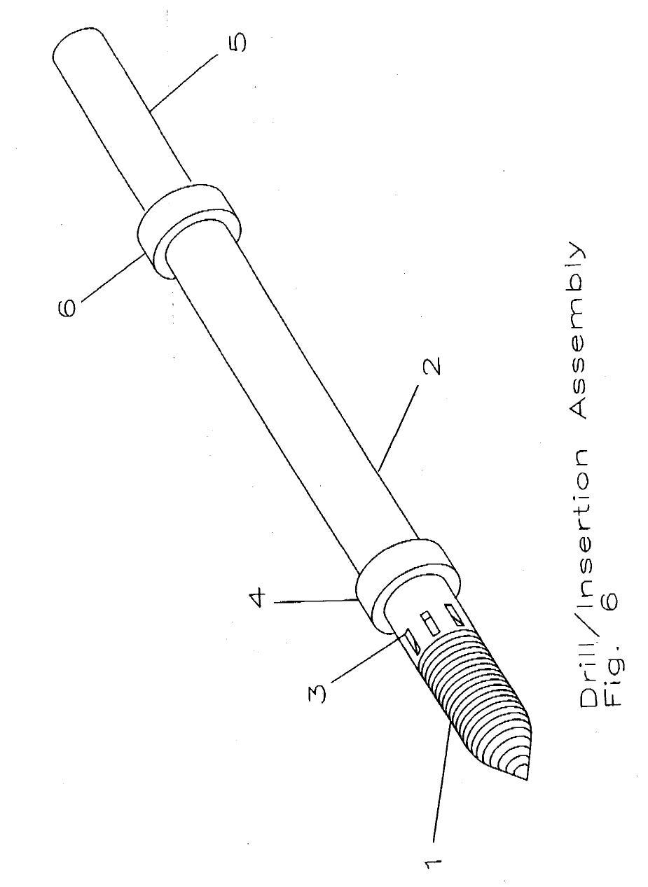

The present invention is designed to provide the nuclear power industry and other organizations that generate nuclear waste, including both low- and high-level waste, with a safe and permanent procedure for its disposal. This involves a special container (FIG. 6) that resists the increasing temperatures by being made of stainless steel. Stainless steel starts to soften at 1100° C. and melts at 1400°-1500° C. Other materials may be used provided that the melting point is greater than that of stainless steel. Ceramic materials, for example, are a usable alternative to stainless steel.

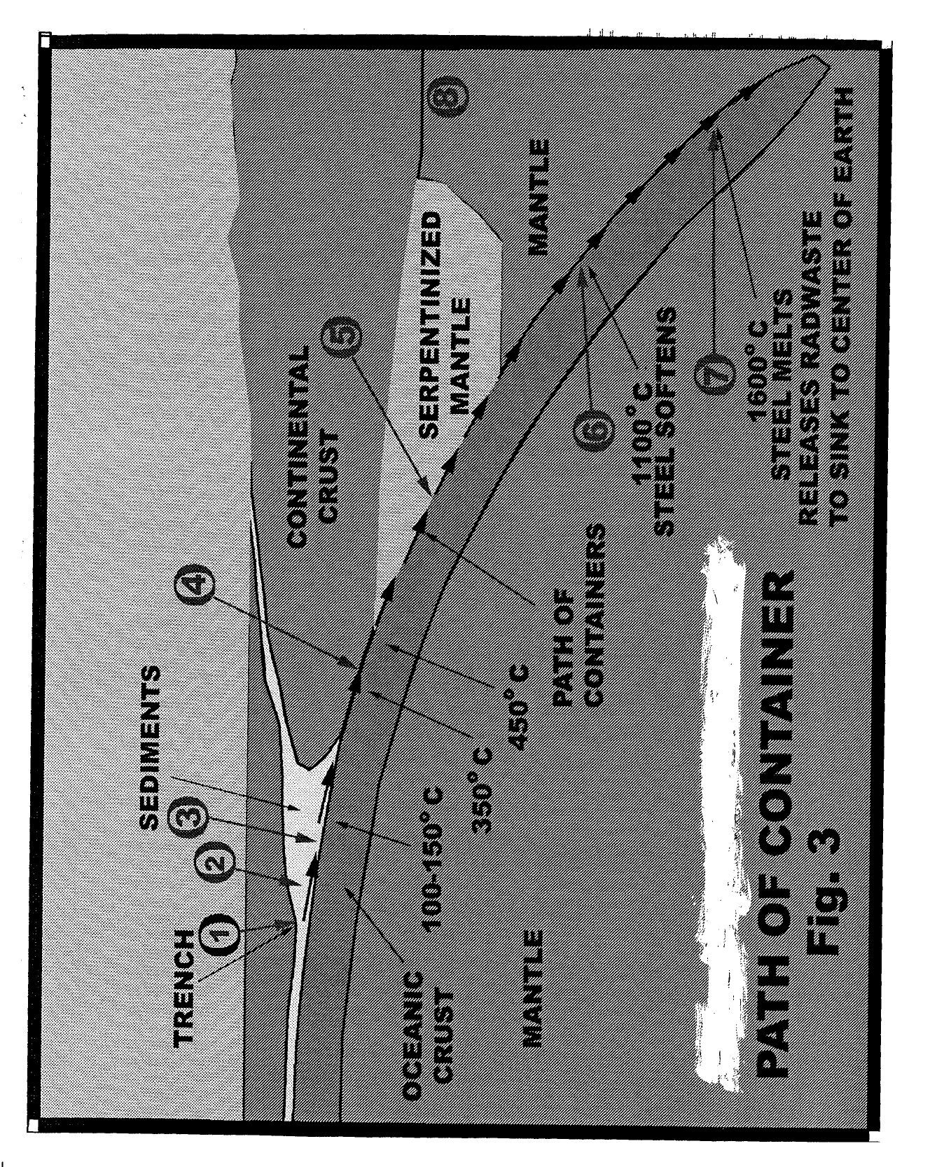

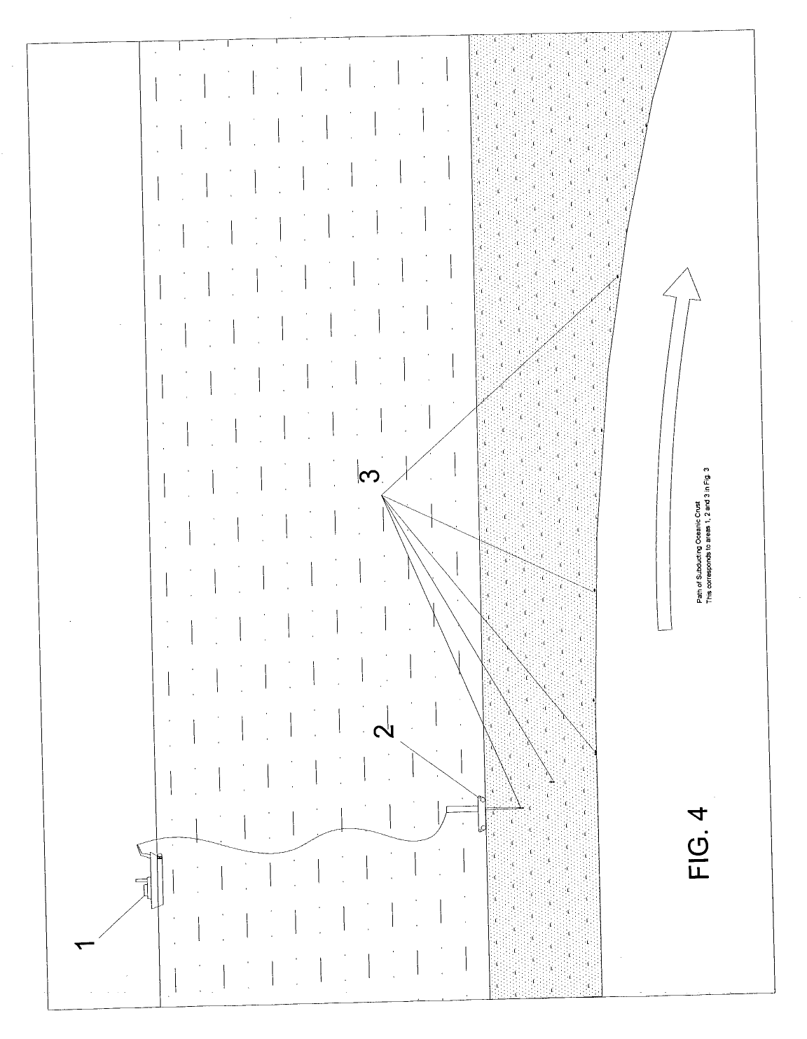

A preferred embodiment of the radioactive waste disposal process begins with the filling of the disposal containers with nuclear waste. The containers are taken by ship to pre-selected locations at a subduction fault (FIG. 3.1) on the ocean floor. A remote-controlled submarine crawler (FIGS. 4.2, 14.1 & 15.1) takes the containers down to the sediments (FIGS. 3.1 & 3.2) over the fault. The crawler drills a hole in the mud for each container that is about 15-20 feet deep, then drops the container in the hole. At a depth of 15-20 feet, there is sufficient mud to eliminate any trace of a radioactive signature at the burial site. Thus any nearby marine life will be protected. In order to avoid violation of international treaties, the disposal container is sealed inside a flexible polymeric covering so that the container, itself, is never in contact with the ocean environment.

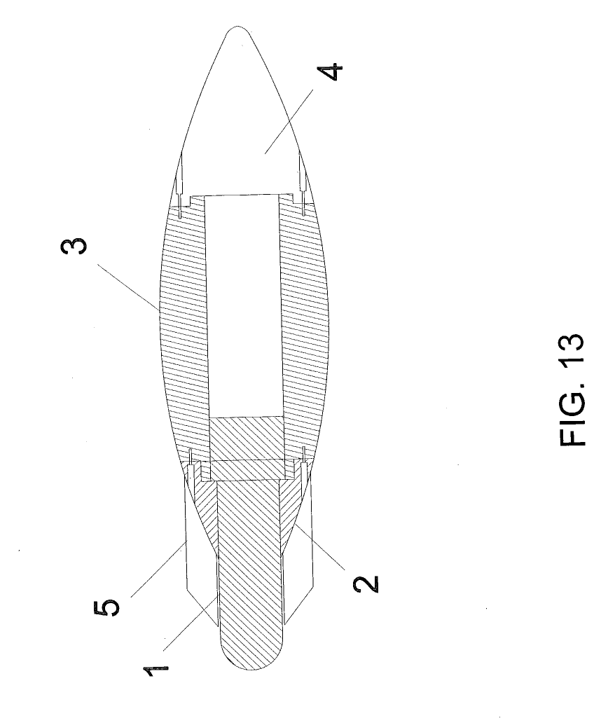

Burying the container in a shallow hole is preferable to merely dropping it on the seabed, although a version (FIG. 13) with a penetrating nosecap (FIG. 13.4) and stabilizing fins (FIG. 13.5) could be dropped from a surface ship (FIG. 4.1). The reason is that the mud protects the Container, Radioactive Waste Disposal from corrosive effects by the seawater on the container. (The preferred material for the container would be stainless steel, but it can be made from a variety of materials, including ceramics.) It also has the advantage of making retrieval by terrorists almost impossible. First it must be located, then extracted from the sediment. Grappling and retrieving the rounded surface would be extremely difficult, and would require a major engineering effort.

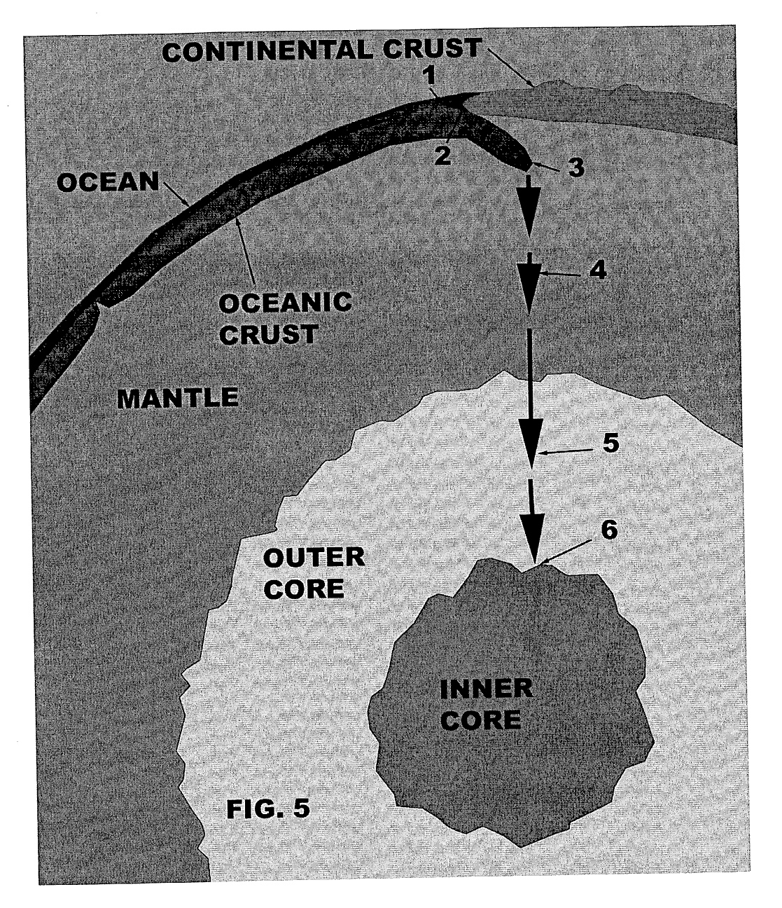

Once buried in mud, all support activity ceases other than general surveillance coverage of the broad area in which the containers rest. The amount of effort needed to even attempt to find and recover one of these containers would be huge and easily noticed by remote surveillance. The containers will quickly (relatively speaking) descend to the bedrock (FIGS. 3.3 & 5.1) of the seabed and gradually be drawn into the subduction fault (FIGS. 3.4 & 5.2) by the subduction motion of the seabed (FIG. 3). Being located in compressed clays and gravel, the containers will continue to travel downward at a faster rate than the surrounding sediments due to their greater mass. (Once in the earthquake zone, even a failure of the container will not release any radiation toward the surface as it will already be under the overhanging continental crust.) Nothing can reverse this process. The containers are drawn down into the mantle (FIG. 3.5) until the heat of the earth's interior starts to soften the metal (FIG. 3.6) in about 6 million years. When the metal fails (FIGS. 3.7 & 5.3), the released radioactive waste is carried still further down into the earth's mantle. After melting, the radioactive waste settles down through the Mantle (FIG. 5.4) and through the Outer Core (FIG. 5.5) until it settles on the mountains of the Inner Core (FIG. 5.6). Long before this happens, the radioactivity within the containers will drop to such a low level as to not be dangerous to anyone.

Burying disposal containers filled with radioactive waste in holes drilled on the ocean floor in the mud adjacent a subduction fault is a relatively economical process. A more detailed description of the drilling and insertion process will now be provided.

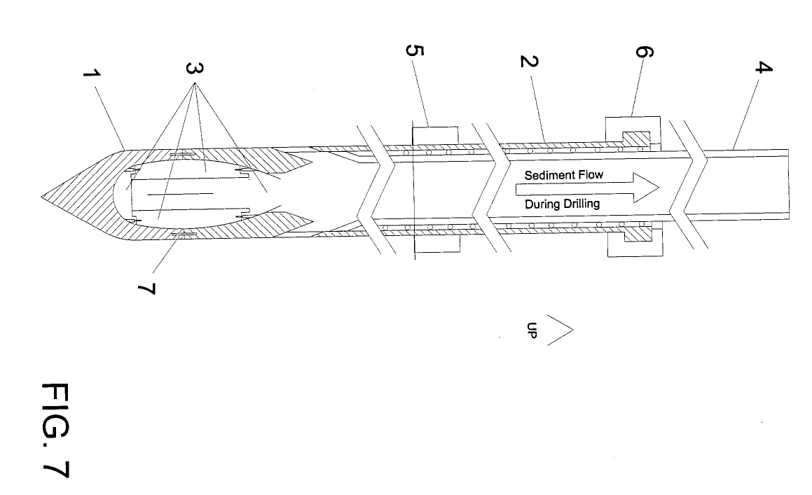

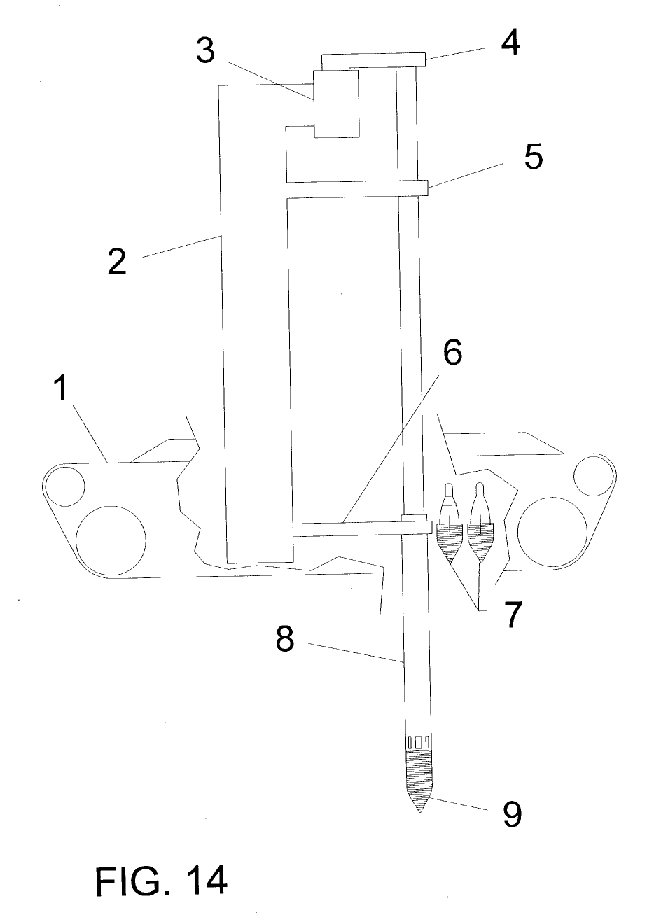

A robot submarine seabed crawler (FIGS. 4.2, 14.1 & 15.1) that can be roughly compared to a gigantic skeletonized Army battle tank without the turret but with a drilling rig, similar to an oil drilling rig, in its place. A preferred embodiment of the crawler has a pair of caterpillar treads similar to those found on a battle tank. That is to say that each tread consists of a continuous roller belt running over cogged wheels. The drilling rig is positioned between the two treads. The crawler may incorporate ballast tanks which enable the machine to descend and ascend in water at a controlled rate. The crawler also serves as a dispenser magazine for multiple radioactive waste disposal containers. (FIGS. 14.7 & 15.8) A one-time-use drill bit is expended with each container, but is not actually connected to the container. (FIGS. 7.1, 8.1, 14.9, & 15.10)

A reusable drill shaft that connects to the drill bit (FIGS. 7.2, 8.2 14.8, & 15.7). This is held in place by a crawler-mounted collar (FIGS. 14.6 & 15.3) at the bottom and the axis shaft (FIGS. 7.4 & 8.2), upon which it slides vertically, at the top.

An axis shaft (FIGS. 7.4 & 8.2) that is inside and coaxial to the drill shaft (FIG. 7.4). The axis shaft is fixed to the crawler and is the full height of the drill rig. It is stabilized at the top by the top end of the shaft (FIGS. 14.4, 14.5, 15.5 & 15.6), while it is stabilized at the bottom of the crawler by a collar (FIG. 7.5)) that captures the drill shaft which, in turn, captures the axis shaft due to the roller interface between the two shafts.

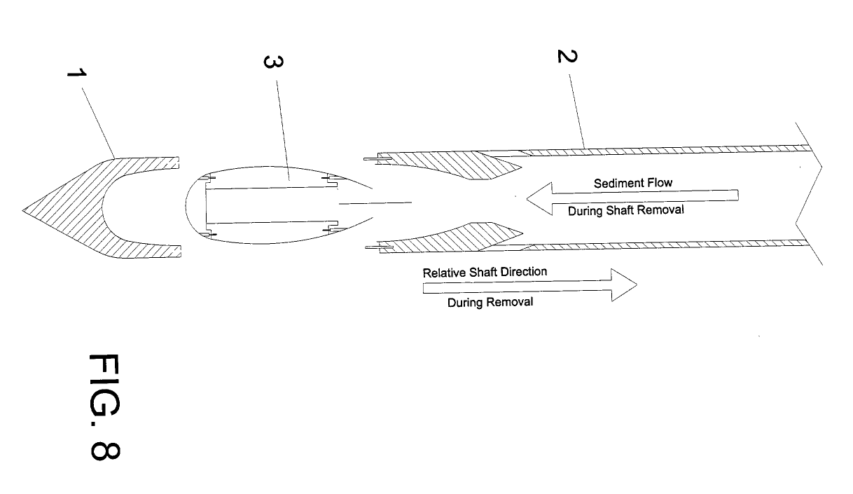

A vacuum assembly (not shown, but at the top of the axis shaft (FIG. 7.4) for drawing mud and sediments into the central axis shaft of the drill assembly during the drilling. When the drilling is finished, the drill bit and container are released (FIGS. 8.1 & 8.3) and the drill shaft is being retracted, the sediments that were drawn into the axis shaft are now allowed to dump into the hole, burying the container.

The shape of the assembly allows the disposal container to slip from a high pressure area to a lower one as it travels through the sediments in the subduction fault region. The movement is analogous to squeezing a watermelon seed. There are no external projections that might cause it to snag on the rock surrounding it. The preferred material of all parts except the lead seal is stainless steel. Other materials may be used, depending upon specifications.

The procedure of burying disposal containers filled with radioactive waste includes a number of steps.

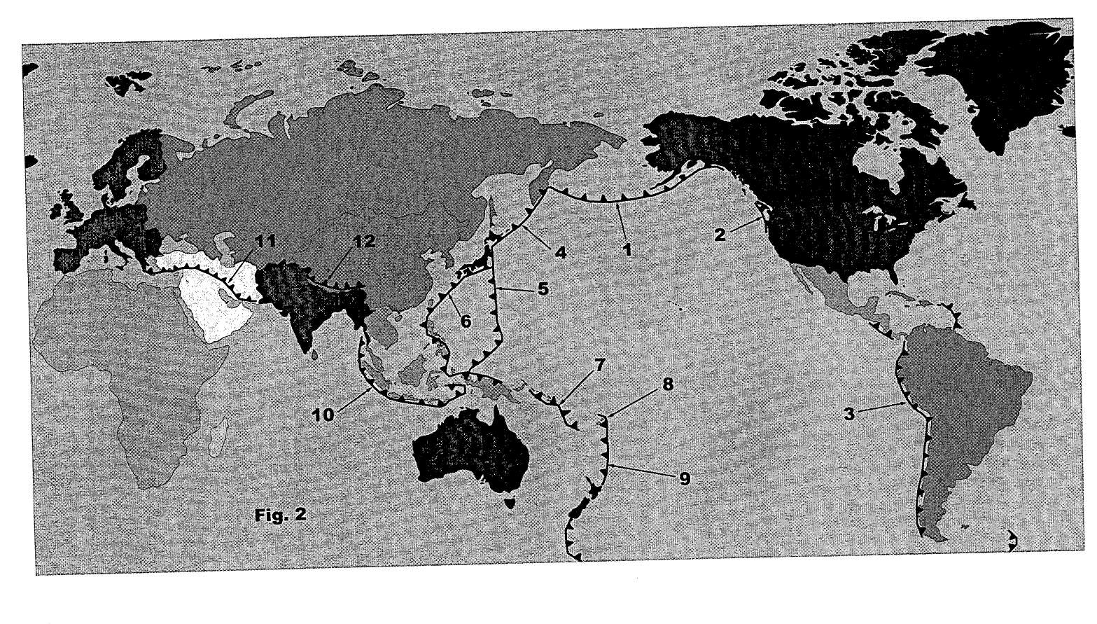

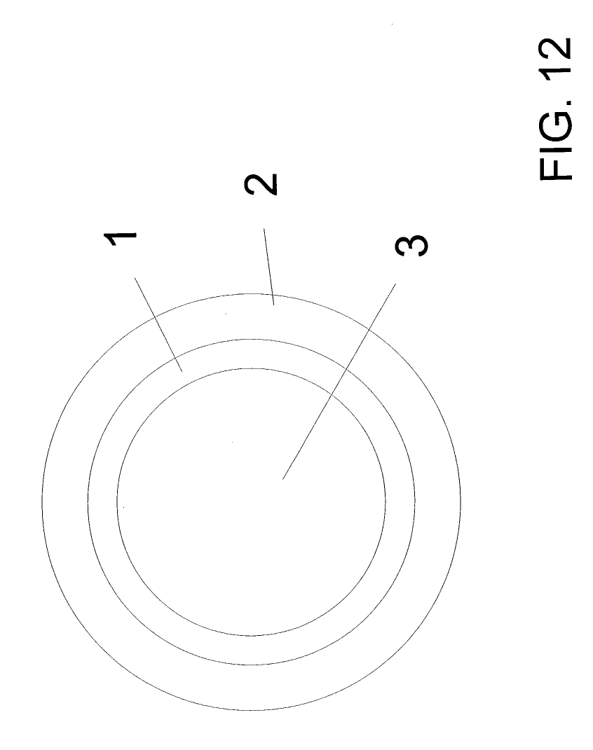

The first step is to identify an appropriate subduction fault in which to plant the containers. For example, the Aleutian Trench (FIG. 2.1) is approximately 1800 miles long by 150 miles wide, providing a huge amount of undersea real estate suitable for buried containers. All ocean-bottom subduction faults are suitable as disposal sites. Two major subduction faults are located on landmasses, one in the Middle East (FIG. 2.11) and the other in the area forming the border region between China and India (FIG. 12). These are not suitable due to (1) accessibility by terrorists and (2) the lack of immediate increase in pressure on the containers to maintain a tight seal.

The second step is that of loading nuclear waste into a disposal container. This would most safely be performed at reactor sites.

The third step is that of transporting the container to a port with a mother ship. The preferred method would be by water, because if an accident were to occur, submergence in water would strengthen the container. Also, the surrounding water would act as an efficient shield, allowing time for recovery.

The fourth step is that of transporting the containers to a subduction fault on the mother ship, which carries the submarine crawler. Each of a plurality of filed disposal containers is married to a disposable drill bit and then loaded on the submarine crawler. The mother ship travels to a subduction fault where it lowers the unmanned submarine crawler to the sea floor. This is usually at a depth of between 5 and 7 miles.

The fifth step involves selection of a drill bit/container assembly and connection of the drill-bit/container assembly to the insertion shaft with automatic quarter-turn bolts.

Referring now to FIG. 7.4, the sixth step involves drilling a hole in the sea floor sediments using the drill/insertion/container assembly. As the hole is drilled, the sediments are vacuumed into the interior of the axis shaft. When the proper depth is reached, the drill bit is released by reversing the quarter-turn bolts, which also releases the container. As the shaft is being retracted from the hole, the sediments in the center of the shaft are free to bury the container and the discarded drill bit. Once the drill shaft is completely retracted, it cycles onto another container pre-packaged with another drill bit, locks onto the new drill bit and the cycle repeats itself.

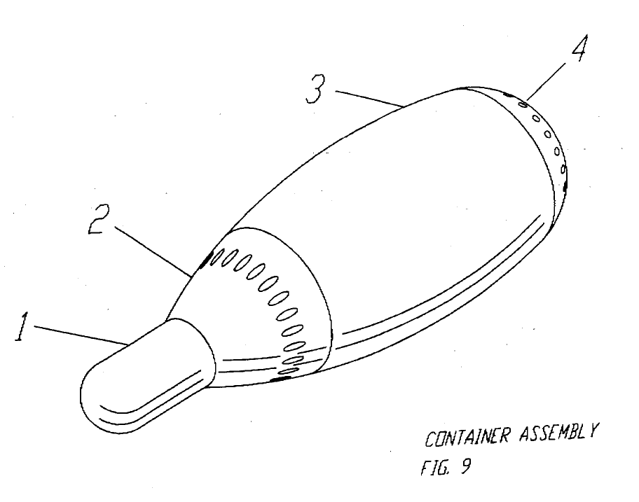

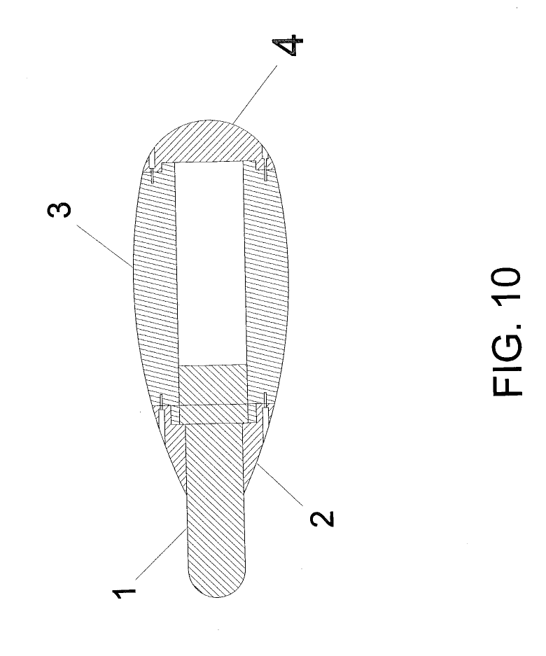

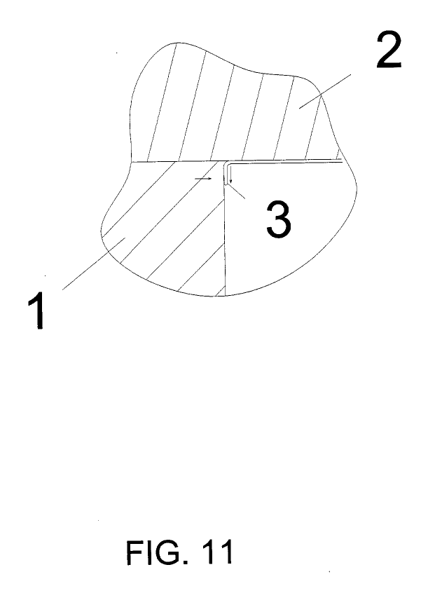

Referring now to FIGS. 9, 10, 11 and 12, the radioactive waste disposal container includes the following components: a container body having a generally cylindrical interior and an exterior surface (FIG. 10.3) that bulges in a manner that presents a curved surface to the rock pressing in from all sides. The only external surface not presenting a convex surface is that of the shaft of the piston-plug; a piston-plug (FIG. 10.1) which fits into one end of the container; a collar (FIG. 10.2) which captures the piston-plug and bolts it to the container; an end cap (FIG. 10.4) which bolts to the other end of the container to seal in the waste; a lead liner (FIG. 11.3) on the interior cylinder wall which becomes a traveling sealant as pressures increase. (Note: this material may be any suitable metal or alloy.); optional all-metal O-rings (FIG. 12). These can only be used where the gland does not require the O-ring to be stretched for loading. There are four methods for this: (1) where two surfaces join by motion perpendicular to the mating surfaces, (2) designing an O-ring gland to allow an oversized O-ring to “S-turn” within the gland once in place, (3) designing an O-ring gland that “S-turns” to match the length requirement of the O-ring, and (4) creating an O-ring gland at a 90 degree mating joint.

An alternative method of inserting the container into the seabed sediments is to free-drop it from the mother ship. This only works if the sediments are penetrable by a streamlined container going at speed straight down. The target depth is to penetrate a minimum of 15 feet plus the length of the container.

An alternative method of inserting the container into the seabed sediments is to free-drop it from the mother ship. This only works if the sediments are penetrable by a streamlined container going at speed straight down. The target depth is to penetrate a minimum of 15 feet plus the length of the container.

What is claimed is:

1. A method of disposing of radioactive waste comprising the steps of:
providing a pressure-equalizing container;
filling the pressure-equalizing container with radioactive waste; and
burying the waste-filled container in a subduction fault.

2. The method of claim 1, wherein the subduction fault is located in the ocean.

3. The method of claim 1, wherein the waste-filled container is buried in sediments on the ocean floor.

4. The method of claim 1, wherein the waste-filled container is buried in a hole drilled by a boring and transport vehicle having a pair of caterpillar treads.

5. The method of claim 1, wherein said pressure-equalizing container comprises:
a chamber body having a generally cylindrical interior and a convex external surface;
a piston plug movable within the cylindrical interior;
a collar which captures the piston-plug and is affixed to one end of the chamber body;
an end cap which is attached to the other end of the chamber body to seal in the radioactive waste; and
a soft metal liner coating the generally cylindrical interior of the chamber body, said liner coating becoming a traveling sealant as external pressures increase.

6. The method of claim 5, wherein the soft metal liner is fabricated primarily of lead.

7. A pressure-equalizing container for storing radioactive waste in sediments on the ocean floor at a subduction fault, said container comprising:
a chamber body having a generally cylindrical interior;
a piston plug movable within the cylindrical interior;
a collar which captures the piston-plug and is affixed to one end of the chamber body;
an end cap which is attached to the other end of the chamber body to seal in the radioactive waste; and
a soft metal liner coating the generally cylindrical interior of the chamber body, said liner coating becoming a traveling sealant as external pressures increase.

8. The pressure-equalizing container of claim 7, wherein said chamber body has a convex external surface.

9. The pressure-equalizing container of claim 7, wherein said soft metal liner is fabricated primarily of lead.
